(19) United States
(12) Patent Application Publication
(10) Pub. No.: US 2021/0180713 A1
(43) Pub. Date: Jun. 17, 2021

(54) Variable Speed Motorized Valves with Sensors and a Network Control System

(71) Applicant: Michael Antonio Mariano, Rialto, CA (US)

(72) Inventor: Michael Antonio Mariano, Rialto, CA (US)

(21) Appl. No.: 17/182,941

(22) Filed: Feb. 23, 2021

Related U.S. Application Data
(63) Continuation-in-part of application No. 15/613,216, filed on Jun. 4, 2017, now Pat. No. 10,948,100.

(51) Int. Cl. F16K 31/04; F16K 31/05; G05D 7/06; F16K 37/00

(52) U.S. Cl. CPC F16K 31/047; F16K 37/0041; G05D 7/0652; F16K 31/05

(57) ABSTRACT

Apparatus is provided to proportionally actuate a valve stem/assembly and electronically control actuation speed and/or torque of the valve. The device has sensory control, wherein sensors is connected in conjunction with the variable speed valve(s) and the electronic output of the sensors is connected to an input upon a microcontroller. The Sensory inputs are utilized to, read and/or write data, to control the actuation speed, torque, and/or position of a valve autonomously. The Network_Control_System is a means to send signals to the microcontroller, in-which send a signal to a driver, moreover send a signal to control, one or more motorized Valves. In addition, the gear box is manually adjustable, in-which is a means for a user to maneuver through a plurality of different gear patterns and/or driveshafts settings to further vary the actuation speed and/or torque of the valve, hence actuate the valve to a precise position.

### CROSS-REFERENCE TO RELATED APPLICATION

This application is a continuation-in-part of U.S. patent application Ser. No. 15/613,216, filed Jun. 4, 2017. This application repeats a substantial portion of the prior application Ser. No. 15/613,216, and adds disclosure not presented in the prior application. Because this application names the inventor named in the prior application, it constitutes a continuation-in-part of the prior application.

### BACKGROUND OF THE INVENTION

The Variable Speed Valve is an electronic operating valve, in-which is constructed with a Stepper Motor, Servo motor, and/or dc motor conjoined to an adjustable gearbox, and moreover, connected to any type of valve. The said motor that actuates the valve is a brush-less and/or AC/DC operated electromagnetic apparatus, in which a controller converts digital pulses into variable speed mechanical shaft rotation. Stepper motors divide a full rotation into a certain number of steps and can range from micro stepping to full stepping procedures. Stepper motors also allow precise positioning control without the need for a feedback system, as well as being capable of continuous rotation. AC/Dc motor driven device will be accurate because of proper braking techniques, but not as accurate as the stepper motor. The servo motor driven device is the closest to accuracy to the stepper motor driven device, but all are within the 99.4%-99.9% accuracy range.

The Variable Speed Valve has no need for a feed-back system, but in order to operate autonomously, a Sensory feedback system was a necessity. The system monitors, control, determines, and/or save a plurality of data. Also, for a user to Operate more effectively, a wired and/or wireless network controller system was implemented to monitor and/or control a plurality of Variable Speed Valves and/or sensory inputs from one or more central controller(s) and/or a plurality of local controllers. These missing necessities is where this New apparatus was developed from. Now Introducing, the Variable Speed Motorized Valves with Sensors and a Network Control System. The “Variable Speed Motorized Valves with Sensors and a Network Control System”, will furthermore, be also titled as the “VSV with NCS”. The apparatus (VSV with NCS) has many functionalities. This Patent will focus mostly on the motorized valve with an adjustable gearbox's sensory control aspect, and moreover, concerning the controller aspect of controlling multiple Variable speed Valves and sensors in different locations, from one or more central locations or from a local controller at the Variable Speed Valve location. The said apparatus can output water, gas, and/or oil at a local piping supply by utilizing the input system via one of the central controllers and/or the said apparatus can output water, gas. And/or Oil at a local piping supply by utilizing the input system upon one of the local controllers. The said apparatus also can save repetitiously used liquid depths for anytime access. The user can auto-fill saved liquid depths with automatic cut-off. The VSV with NCS also has a measurement system to output a plurality of volume sizes by way of motion sensors, auditory signals, and/or the input system upon one of the wired or wireless controller's user interface. The apparatus also has a plurality of sensors and/or automatic timers upon the plurality of microcontrollers and/or Digital signal processors to control and/or monitor sinks, faucets, showers, tubs, sprinklers, swimming pools, toilets, water heaters, water main-lines, Gas Main-lines, Oil pipelines, Air Main-lines, swamp coolers, air conditioners, and/or any local water, Gas, Oil, and/or Air pipeline supply. The VSV with NCS is the answer for anybody who want to have the faucet of their choice and control their entire home and/or business water supply electronically. The said apparatus is universal, which means, it can control the flow and/or pressure of water, Gas, Oil, and/or Air with a network control system buy connecting to any piping supply the user has in mind, or the user can use the manual faucet or electronic faucet of their choice. A user can control all their Utility supply needs from anywhere in the world, while also controlling how fast their Variable speed Valves actuate to their needed position.

### BRIEF SUMMARY OF VARIOUS EMBODIMENTS OF THE INVENTION

The “VSV with NCS” now makes it possible to monitor and/or control any pressure, temperature, mixing purpose, mixing colors, and/or turn on/off any Variable Speed Valve type. This system can be utilized within the oil/gas industry, water industry, air regulation systems, and/or can be used to control and/or monitor the flow and/or pressure for any substance and/or air being distributed through a piping system. This will enable the entire facility to be controlled in a single network. Various embodiments of the invention include, but not to be limited to, one or more central controllers, a plurality of local controllers, sensors, and/or one or more Variable speed valves. The central controllers are either a wired or wireless controller with inputs such as physical switches, motion sensors, voice command, touch screen, or any input type. The central controller can also be a mobile device, and/or a computation Device. The central controller is utilized to send control signals to the plurality of local controllers, which a plurality of local controller systems is connected to a plurality of Variable speed valves, and/or sensors, moreover, the local controllers' control and monitor the flow and/or pressure of a local pipe supply, but also the local controllers have a user interface to control its devices that are connected to the local pipe supply. The central controller has hot, cold, and warm water inputs, Gas/Oil/Air control inputs, menu inputs, a microcontroller, electronic liquid overflow sensor inputs, a plurality of monitoring sensor inputs, on-board motion sensors, Bluetooth/WIFI/Lora, and/or any wireless communication transceiver device to send and/or receive control signals to and/or from the local controllers. The central controller functions consist of, depth saving functions to save repetitiously used liquid depths for any time use, a plurality of Liquid/Gas/Air volume size select inputs, automated Water, Gas, Oil, and/or Air main-pipeline functions, and/or Water, Gas, Oil, and/or Air type sensors to start and/or stop the flow of Water, Gas, Oil, and/or Air. The central controller is the global controller that can control a plurality of local controllers from anywhere in the world. The apparatus has a plurality of wired/and or wireless Local controller user interfaces which is a microphone, one or more motion sensors, and/or any type of input control signals, microcontroller(s), and a Bluetooth/WIFI/Lora and/or any communication transceiver device to send and./or receive control signals to and/or from a controller. The apparatus has a first Local controller which is constructed with hot, cold, and warm water inputs, menu inputs, electronic liquid overflow sensor inputs, Water, Gas, Oil, and/or Air monitoring sensor inputs, a microcontroller(s), Bluetooth/WIFI/Lora and/or any wireless transceiver communication device to send and receive control signals to and/or from a second or third local controller. The first local controllers are utilized for easy control of one or more of the apparatus's many functions, moreover, can be set to operate any function the VSV with NCS, local device, has to offer. A second local controller is constructed with electronic liquid overflow sensor inputs, Water, Gas, Oil, and/or Air monitoring sensor inputs, and/or one or more Variable Speed Valve(s) inputs. The second local controller is the controllers which is connected to an Electronic drain stopper device, Water, Gas, Oil, and/or Air sensors, and/or Motorized valves. The second local controller is utilized to control and/or monitor the pressure and/or flow at each Variable Speed Valve(s) in a online and/or offline mesh network. The first local controller can also be a second and/or third local controller. Some systems have a plurality of local controllers with a plurality of user interfaces to control the local Variable Speed Valve(s). The VSV with NCS can be controlled by one or more controllers In Its same Network. The electronic mesh network that is created, through all devices being connected on one network, will be called the Mariano Network. The Adjustable gearbox, upon the Variable Speed Valve, is utilized to adjust the speed and/or torque by changing to certain gear patterns embedded into the housing of the gearbox. Changing the adjustable settings of the gearbox will deliver more or less speed and/or more or less torque by changing the gears teeth count for a greater or lower turn ratio. The adjustable gearbox is manually adjustable, in-which the controller can still control the speed and/or torque of the manually selected gear pattern, but only between a certain range. If the user want to electronically control the apparatus at a lower range and/or higher range, the user must manually adjust to a different gear pattern setting. The electronic speed control functionality will allow a user to, for example, speed up valve actuation for a user to not get burned because the valve turns off to slow and/or will allow a user to slow down the speed to gain exact positioning of the valve. The combination of using a certain gearing position and the electronic speed control functionality allow a user to control their valve in a plurality of stages. These stages consist of, for ex, slow-speed, medium-slow speed, medium speed, medium-high speed, high speed and/or Many more. The Variable Speed Valve, because of the sensory inputs, can autonomously maneuver to all stages. This Is the “First Network Controlled Utility Distribution system” for Water, Air, Oil, and/or Gas in-which a user can manually and/or autonomously control actuation speed of a valve.

Various embodiments may include variations in the shape, material, construction method, size of various constructed machined parts, gearbox, motors, and/or valves used in conjunction with the “VSV with NCS”. Various embodiments may also allow for variations in the design of the electronic components used in conjunction with the “VSV with NCS”.

### BRIEF DESCRIPTION OF THE DRAWINGS

FIG. 1A-1B —Illustrates two versions of an Variable speed Valve with external inline sensors, according to various embodiments of the invention.

FIG. 1C—Illustrates an Variable speed Valve's manual multi speed/multi torque adjustable gearbox and/or adjustable transmission, according to various embodiments of the invention.

FIG. 2A-2B—Illustrates a diagram of an Variable speed Valve with internal sensors, designed for indoor/outdoor use, according to various embodiments of the invention.

FIG. 3A-3B—Illustrates a diagram of an Variable speed Valve with internal sensors designed for outdoor door use according to various embodiments of the invention.

FIG. 4—Illustrates a first basic schematic of the ‘VSV with NCS” local network controller(s) according to various embodiments of the invention.

FIG. 5—Illustrates a diagram of the ‘VSV with NCS”, and in addition, the Illustration Depicts an example of a first basic remote control unit and a second main controller unit according to various embodiments of the invention.

FIG. 6—Illustrates the ‘VSV with NCS” and its connectivity between a plurality of solar powered and/or turbine powered local controllers. The local controllers connect to one or more sensory inputs and/or Variable speed valve(s) at each water and/or GAS main-line connection of a plurality of homes and/or businesses, furthermore, depicts how the central controller's user interface (or a mobile device) at the water utility company and/or Gas Utility Company can monitor and/or control the pressure and/or flow of water and/or Gas entering each user's home and/or business.

FIG. 7—Illustrates the “‘VSV with NCS”” and its connectivity between Variable speed Valves, the central controller, and a local controller, furthermore, the local controller and Variable Speed Valves is connected to a Water, Oil, Gas, and/or Air piping system.

FIG. 8 Illustrates the ‘VSV with NCS”” and its connectivity between the solar powered central controller and a plurality of solar powered local controllers. Furthermore, the plurality of local controllers is connected outside the user's home to a plurality of Variable Speed Valves and sensors at each local water supply connection such as a shower, a tub, spa, and/or a swimming pool.

FIG. 9 Illustrates a second schematic of the ‘VSV with NCS” Network Controllers. This schematic is used to prove a great novelty of the invention, and moreover, the schematic does not disclose a full version of the capabilities of the system, but it does, substantially, depict how to control one or more Variable Speed Valves and Sensors with a network control system.

### DETAILED DESCRIPTION OF VARIOUS EMBODIMENTS

Various embodiments of the invention are described more fully hereinafter with reference to the accompanying drawing, in which some, but not all embodiments of the invention are shown in the figures. Indeed, these inventions may be embodied in many different forms and should not be construed as limited to the embodiments set forth herein; rather, these embodiments are provided so that this disclosure will satisfy applicable legal requirements.

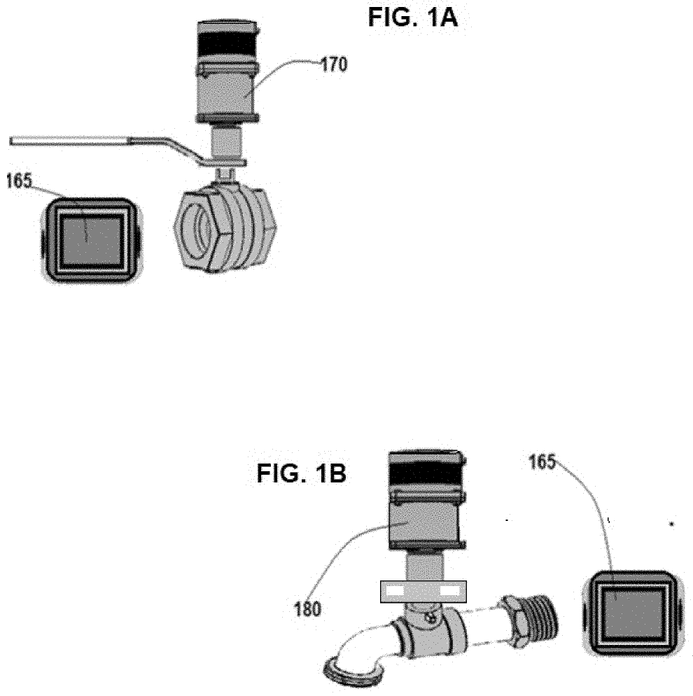

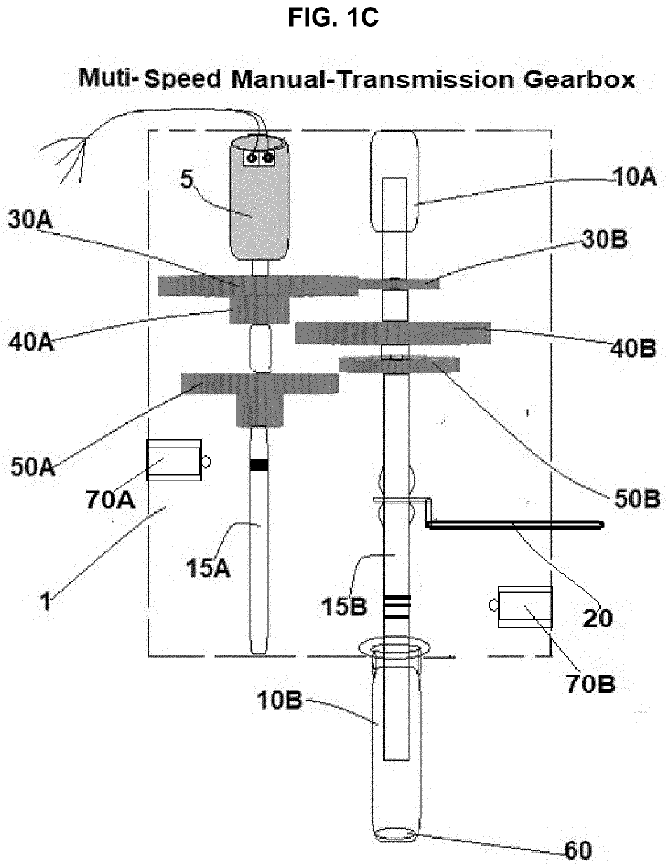

FIG. 1A-1B Illustrates two of the main embodiments of the invention. As shown, a Variable speed Valve (170) includes a motor (Stepper Motor, DC Motor, AC Motor, and/or Servo Motor), an adjustable gearbox in which can be manually adjusted, one or more drive shafts, a valve, an external sensory device (165), an all-off switch or positioning sensor in which tells the microcontroller the valve position or that the valve is completely off, and is also constructed with/without an emergency manual shutoff. These are 7 of the major components that make up the “Variable speed Valve”. The “Variable speed Valve” constructed with a ball valve, butterfly valves, and/or any valve with no interchangeable parts, are designed to last because it has no interchangeable parts. There are no diaphragms, no washers to ever change, or no needles or wore out springs to change or replace. The “Variable speed Valve” constructed with a diaphragm valve and/or any other valves with, diaphragms and/or washers, will have interchangeable parts. A User can control one or more “Variable speed Valve” by means of the Variable speed Valve's plurality of controllers upon the network control system. The apparatus can also be controlled by any system that can control a motor. FIG. 1-A, furthermore, illustrates the “Variable speed Valve” (170) used for indoor/outside use. It can be Used to control all local supply of water in your home/office kitchen or bathroom. The sensory input (165), are utilized for sensing temp, pressure, flow rate, valve position, a substance presence, and/or for automating the valve. The sensory inputs can be embedded with the valve construction and/or the sensors can be external devices. In addition, the sensory inputs upon the valve are interchangeable and/or stationary devices, wherein a user can change the interchangeable sensor to control multiple different applications. Other specific areas that the “Variable speed Valve” and controllers (or the “Variable speed Valve” alone) can be utilized for range from following: Precisely regulate liquid distribution, Main line automated shut on/off, all water shutoff and regulation solutions, precisely regulate any and all gas measurements (or automate gas shutoff/turn on), can precisely measure and regulate air pressure, can control the speed of how fast each Variable speed Valve actuate, and multiple other system uses. FIG. 1-B illustrates the “Variable speed Valve” (180) used for outdoor use. The “Variable speed Valve” (180) and controller (or the “Variable speed Valve” alone) can be utilized from a range of the following: Precisely regulate any liquid and/or gas distribution, water hose (hose bib), washing machines, a gas station pump, Agriculture distribution system (watering plants), and multiple other system uses. The sensory input (165), are utilized, for ex: sensing temperatures, pressure, flow rate, valve position, and/or for automating the valve.

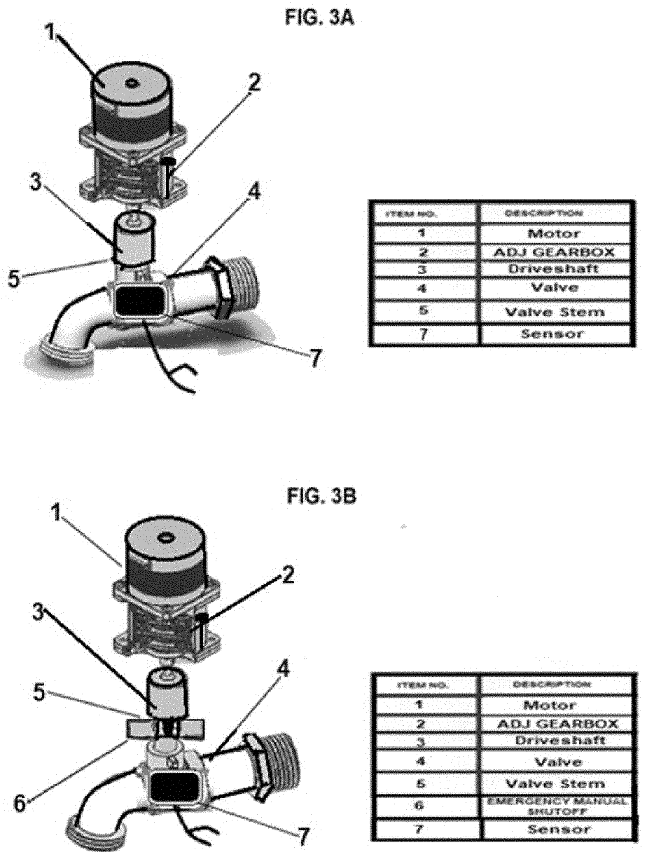

FIG. 1C Illustrates an embodiment of an Variable speed Valve's manual and/or autonomous multi speed/multi torque adjustable gearbox (1) and/or adjustable transmission (1). The Variable speed Valve with a, manual gearbox (1) is created with, a motor (5A). The motor (5A) is the actuating device in-which actuates the valve stem. The actuating devices (5A) can be any type of motor and/or solenoid. The device will be made with many different speed/torque stages, ranging from, for example: 2-Speed/torque settings-8 Speed/torque settings. In some instances, even more. In this particular embodiment is a 3 speed/torque manual gearbox (1) and/or transmission (1). It has 3 separate gearing patterns in which can be adjusted. For Example: Gear Pattern One ((30A and (30B)): is the slowest possible speed settings and the torque range is moderate. Gear Pattern two ((40A and (40B)): has fast possible speed settings and the torque range is very high. Gear Pattern three ((50A and (50B)): has medium speed settings and the torque range is medium. The lever (20) is utilized to manually change the gear pattern settings. In FIG. 3, the Illustration will depict a lever on the outside of the gearbox. The Lever on the outside of the gearbox is connected to the lever (20), in which is connected to the gear select driveshaft (15B). The user will move the driveshaft (15B), up and/or down, until it reaches its specific gear pattern to engage upon. Once the gear pattern is engaged, the driveshaft (15B) will lock in place and no longer proportionally move, up and/or down. Now that the gear pattern is locked in place, the actuating device (5a) can now actuate that specific gear pattern arrangement, in-which will actuate the driveshaft (10B). Moreover, the drive shaft (10B) is connected to the valve assembly/valve stem at the bottom of the driveshaft (60), and furthermore, can now proportionally Actuate a Valve. The drive-shafts can also have one or more springs for a better interaction with the valve positioning. The system can be assembled to any valve type. The motor and/or gearbox is a universal and/or a removable device in which can connect to any manual Valve. The motor and/or gearbox system will also be constructed, wherein it cannot be removed from the valve and/or assembled to any valve. This Motorized Valve was constructed with an actuating motor (5A), in which is conjoined to a first plurality of gears upon a first adjustable gearbox drive shaft (15A). A second gearbox drive shaft (15B), with a second plurality of gears, is then connected to, one or more, machined cylinder housing ((10A) and (10B)). The motor will actuate the gears upon the first driveshaft (10A), and moreover, will catch the gears upon the second driveshaft (10b). The second driveshaft (10b) at point (60), will moreover, join the gearbox (1) shaft to any valve. The coupling/drive shaft (10A AND 10B) is then, secured to both sides of the gearbox (1) and the valve by machined screws. Lastly the position sensors and/or switch ((70A and/or 70B)) is assembled to, sense the position of both driveshafts (15A) and/or (15B)), to alert the user of the valve position and/or to autonomously actuate a valve to a specific position. All sensors can be internal and/or external sensory inputs. In conclusion, the Valve is now ready to be Variable Speed Controlled. Please keep in mind that this Valve Assembly will be constructed in many other different ways utilizing similar mechanical parts and/or electrical components. The above is just examples of a functioning variable speed valve, and will be further advanced in the future.

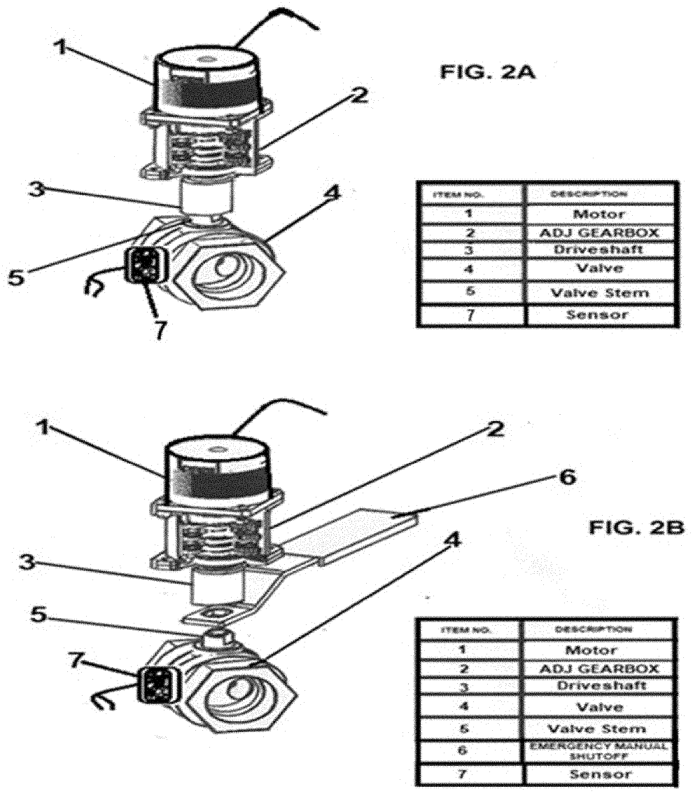

FIG. 2A-2B Illustrates a diagram of the “Variable speed Valve” for indoor/outdoor use according to the various embodiments of the invention. FIG. 2-A display the “Variable speed Valve” without emergency shut-off. FIG. 2B display the “Variable speed Valve” assembled with an emergency shut-off (5). This diagram depicts the parts used to make the apparatus functional. The stated “Variable speed Valve was created with a motor (1), a precisely ratio adjustable gearbox (2), and a valve assembly (4). The device will be made in a plurality of different ways. The gearbox is assembled to the shaft of the motor. The gearbox (2) shaft is then connected to a machined cylinder housing, the coupling/driveshaft (3), to join the gearbox (2) shaft to the valve (4). The coupling/drive shaft (3) which is then secured to both sides (the gearbox and the valve (4)) by machined screws. This was done to create smoother operations and maximum speed and/or torque delivery. The gearbox of the device is manually adjustable, in which is a means to adjust the gearbox to many different preset gear patterns. For Ex: In order to turn the valve (4) to a precise angle with high torque/slow speed, the motor and gearbox turn ratio had to be changed to a smaller step size. For this to work, a first gearing pattern in the gearbox (2) had to be implemented to decrement the step ratio from 1.8 degrees to 0.008 degrees' step size. This gearing pattern is the normally set gear pattern. This first gear pattern setting is the slowest actuating gear pattern setting, but also the most accurate gear pattern setting. On behalf of the medium torque/medium speed “Variable speed Valve” gearing position, a second gear pattern was implemented in the gearbox. This second gearing pattern was implemented to transform the step size by making the gear box's (2) second gear pattern's gear ratio achieve 100 steps to the said motor (1) original one step 1.8\100=0.018. On behalf of the low torque/fast speed “Variable speed Valve” gearing position, a third gear pattern was implemented in the gearbox. This third gearing pattern was implemented in the gearbox to transform the step size by making the gear box's (2) gear ratio achieve 50 steps to the said motor (1) original one step 1.8\50=0.036. When there was no gearbox (2) present, the step ratio would be too big and turn the “Variable speed Valve” in 2 revolutions, at highest four revolutions. The sensory inputs (7) are utilized for sensing temp, pressure, flow rate, valve position, a substance/substance presence, and/or for automating the valve. The sensory inputs (7) depicted in the illustration are embedded in the valve construction, but the Variable speed Valve sensors (7) can be embedded with the valve construction and/or the sensors (7) can be external devices. It will also have an off switch embedded in the gearbox housing and/or the controller, and furthermore utilized to alert a user that the valve is completely open and/or closed. The “Variable speed Valve” is designed to a user's preference. Each “Variable speed Valve” is designed for any area of distribution that can be controlled by a valve (4). The specific areas that the “Variable speed Valve” and “Variable speed Valve Motor Controller” (or the “Variable speed Valve” alone) can be utilized for range from following: Precisely regulate inside/outside water distribution (sprinkler, swimming pools, spas, swamp coolers, and/or Air conditioning units). It can be Used to control any and all water faucets in your home kitchen or bathroom/office. Other specific areas that the “Variable speed Valve” and “Variable speed Valve Motor Controller” (or the “Variable speed Valve” alone) can be utilized for range from following: Liquid and/or Gas Main line automation, sprinkler pressure automation, all Liquid, Gas, Oil, and/or Air shutoff/shut-on solutions, precisely output predetermined quantities of liquid, gas, oil and/or Air measurements, a gas station pump controller, Oil Refinery Network Control, precisely measure and/or output air (also regulate the air pressure), and/or multiple other system uses. A Variable speed Valve also come equipped with timers for a user can set timers to automate their valve usage.

FIG. 3A-3B Illustrates a diagram of the “Variable speed Valve” for outdoor use according to the various embodiments of the invention. FIG. 3-A display the “Variable speed Valve” without emergency shut-off. FIG. 3B display the “Variable speed Valve” assembled with an emergency shut-off (5). This diagram depicts the parts used to make the apparatus functional. The stated “Variable speed Valve was created with a motor(s) (1), a precisely ratio adjustable gearbox transmission (2), and a valve (4). The device will be made in a plurality of different ways. The gearbox is assembled to the shaft of the motor. The gearbox (2) shaft is then connected to a machined cylinder housing, the coupling/driveshaft (3), to join the gearbox (2) shaft to the valve (4). The coupling/drive shaft (3) which is then secured to both sides (the gearbox and the valve (4)) by machined screws. This was done to create smoother operations and maximum speed and/or torque delivery. The gearbox/gearbox lever (2) of the device is manually adjustable, in which is a means to adjust the gearbox to many different preset gear patterns. To adjust the gear pattern's in the gearbox of the variable speed valve, a user can twist the gearbox housing and/or a switch/lever (2) will be constructed in-conjunction with the gear box housing. The following will explain why and how the gear patterns where created. For Ex: In order to turn the valve (4) to a precise angle with high torque/slow speed, the motor and gearbox turn ratio had to be changed to a smaller step size. For this to work, a first gearing pattern in the gearbox (2) had to be implemented to decrement the step ratio from 1.8 degrees to 0.008 degrees' step size. This gearing pattern is the normally set gear pattern. This first gear pattern setting is the slowest actuating gear pattern setting, but also the most accurate gear pattern setting. On behalf of the medium torque/medium speed “Variable speed Valve” gearing position, a second gear pattern was implemented in the gearbox. This second gearing pattern was implemented to transform the step size by making the gear box's (2) second gear pattern's gear ratio achieve 100 steps to the said motor (1) original one step 1.8\100=0.018. On behalf of the low torque/fast speed “Variable speed Valve” gearing position, a third gear pattern was implemented in the gearbox. This third gearing pattern was implemented in the gearbox to transform the step size by making the gear box's (2) gear ratio achieve 50 steps to the said motor (1) original one step 1.8\50=0.036. When there was no gearbox (2) present, the step ratio would be too big and turn the “Variable speed Valve” in 2 revolutions, at highest four revolutions. The sensory inputs (7) are utilized for sensing temp, pressure, flow rate, valve position, a substance/substance presence, and/or for automating the valve. The sensory inputs (7) depicted in the illustration are embedded in the valve construction, but the Variable speed Valve sensors (7) can be embedded with the valve construction and/or the sensors (7) can be external devices. The apparatus have an all-on and/or all-off switch, in which is embedded in the gearbox housing and/or upon the controller, to alert a user that the valve is completely open and/or closed. The “Variable speed Valve” is designed to a user's preference. Each “Variable speed Valve” is designed for any area of distribution that can be controlled by a hose bib type valve (4). The specific areas that the “Variable speed Valve” and “Variable speed Valve Motor Controller” (or the “Variable speed Valve” alone) can be utilized for range from following: Precisely regulate outside water distribution (sprinklers, swimming pools, agriculture water distribution (watering plants), spas). The Motorized Valve, is moreover utilized to control any and all local water supplies outside a user's home/office. Other specific areas that the “Variable speed Valve” and “Variable speed Valve Motor Controller” (or the “Variable speed Valve” alone) can be utilized for range from following: Water Drip/Mist Systems, Swamp cooler's, AC's, water hoses, any (hose bib) type valve automation, sprinkler pressure automation, all piping shutoff/shut-on/regulation solutions, precisely distribute a precise predetermined quantity of Liquid, Air, Gas, and/or Oil, precisely measure Liquid, Gas, Oil, and/or Air, and/or multiple other system uses. All Variable speed Valve also come equipped with timers for a user can set timers to automate their valve usage. The “Variable Speed Valve will be assembled with electronic speed/torque control's, a manual speed controller, and/or an electronic and/or manual speed controller.

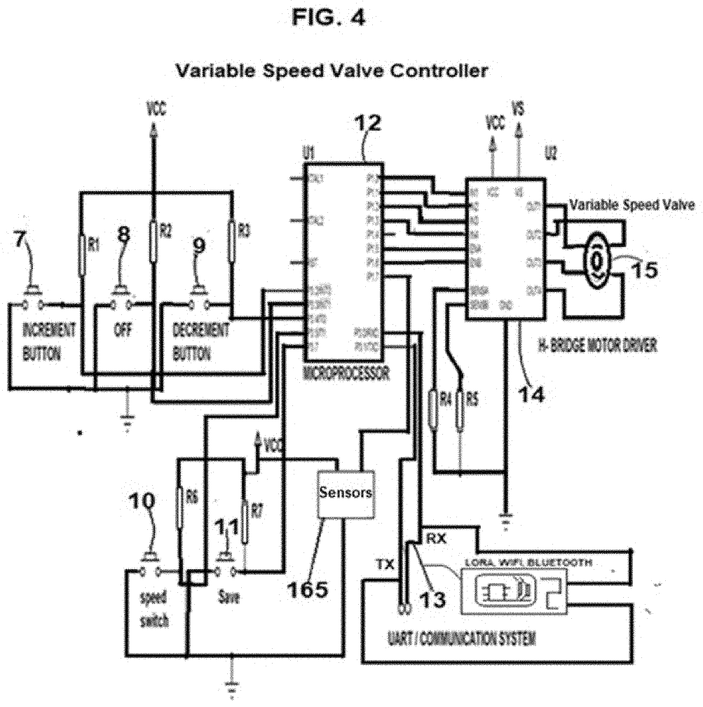

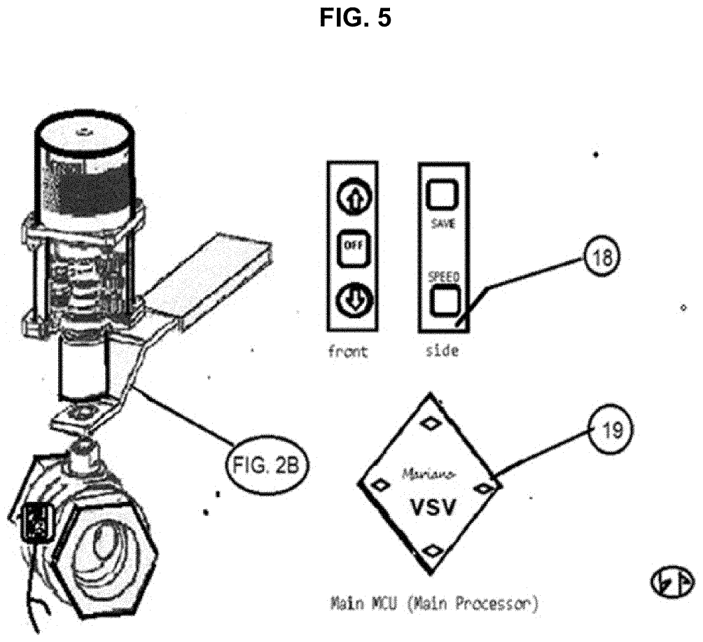

FIG. 4 Illustrates a first basic schematic of a “Variable speed Valve Network Controller”. The “Variable speed Valve Controller” will be embedded in the valve construction and/or will be an external device. As shown, a microcontroller (12), a full h-bridge motor driver (14), some control switches ((7) (8) (9) (10) (11)), a sensory input (165), and a UART system. The UART system (13) is connected to a transceiver (13), to provide wired and/or wireless communication to and/or from the controller and/or the “VARIABLE SPEED VALVE”. Other communication systems that are invented within the time span of this patent will also be utilized with the “Variable speed Valve Controller”. Wireless communication ranging from, IR, Bluetooth, LORA-WANN, WI-FI, ZIGBEE, XBEE, and/or any transceiver device (13) will be utilized to transmit and/or receive data from UART. The motor (15) has to use a h-bridge (14) in order to operate correctly. This is because the coils of the motor have to switch polarity to, open and/or close, the Variable Speed Valve. The microcontroller (12) is utilized to control motor speed, motor rotation, to save user and/or sensory data, and/or to allow inputs to control the “Variable speed Valves”. It is also used to output data through speaker(s), LCD screen(s), vibrator motor, Touchscreen(s), and/or a plurality of LED'S, to alert a user that a function is complete. The buttons in the picture are there for the purpose of depicting switches. The VSV with NCS User Interface will be constructed with voice command, touch-less sensing, touch screen, and/or push buttons. The Increment switch (7) will allow the user to adjust the “Variable speed Valve” step by step in the open position until the user has reached their preference. The decrement switch (9) will allow the user to adjust the “Variable speed Valve” to increments towards the closed position until the user has reached their preference. By pressing the all-on/all-off switch (8), this will allow the user to fully close and/or fully open the valve despite its position. A second all-on/all-off switch will be embedded in the valve housing of a plurality of different Variable Speed Valves constructions. The second all-on/all-off switch (8) and/or positioning sensors will be an input to the microcontroller to alert the microcontroller and/or a user that the valve is 100% closed. The speed/torque switch (10) is used to adjust the various different motor speeds and/or torque settings programmed to the microcontroller. A user can also set their on device speed/torque settings instead of utilizing the preset speeds/torque settings. The speed switch (10) is utilized to control how fast or slow a user want the “Variable speed Valve” to actuate open and/or close. The save switch (11) was added for, if the user has a plurality of valve positions, pressure output settings, and/or sensory data they want to save for future use. This saved data can be used to automate Valve actuation. A user can also set and/or save timer settings, in which can automate the valve actuation. The sensory inputs (165) determine a liquid/Air temperature, flow/pressure rate, substance presence/detection, and/or many more sensor types will be utilized within the apparatus. Different sensory types such as moisture sensors for soil/dirt hydration (agriculture), liquid contaminant sensors (TDS, PPM, EC), PIR sensors (for long distance touchless control), IR (for shorter distance touchless control), Light sensors (to automate day time and/or night time valve automation), Tilt sensors(to control valve actuation or to control the speed of the valves actuation, Valve positioning sensors, and/or much more uses. All of the sensory inputs (165), utilized in conjunction with the apparatus, are commercially sold and communicate with the microcontroller (75) through an input/output pin. The sensory inputs (165), that was stated above will, depending on the end user needs, be utilized in conjunction with one or more VSV with NCS Valves, furthermore, the sensory inputs (165) send and/or receive data, to and/or from, the microcontroller (75) to monitor, control, determine, and/or to save sensory data that was recorded due to different types of activity at a local Variable Speed Valve. The sensory inputs (165) can also start and/or stop the flow of Liquid, Air, Gas, and/or Oil. The Variable Speed Valve Has a Network controller to control one or more Variable Speed Valve's In different locations from one or more central location's and/or from each device local location. This will be further disclosed in FIG. 5-10. This particular “Variable speed Valve Controller” schematic's is present to prove the bare necessities needed to operate a “Variable speed Valve”. This “Variable speed Valve Controller” schematic's is not present to depict the full embodiment of the invention, but only to prove validation.

FIG. 5 Illustrates a “Variable speed Valve” With a first basic “Variable speed Valves Network Controller” according to various embodiments of the invention. The “Variable speed Valves Network operated Motor Controller” will be equipped with multiple controller options to choose from. According to various embodiments the “Variable speed Valves with NCS Motor Controller” is assembled with a power supply, a transceiver, one or more microcontrollers, and a driver. System can be powered by Solar, Salt water Technology, and/or a turbine device. Some plurality of systems will come with embedded battery packs and charging systems, while some system will be constructed to power from non-reusable batteries. The controller (18) can be embedded into the valve housing and/or can be an external device. The main unit (19) is a second controller unit, that will be utilized in some wireless controlled VSV with NCS devices. Wherein the first controller (18) sends and/or receive wireless data to and/or from the main unit/second controller (19), to control variable speed valves (FIG. 1-FIG. 3) and sensors at the location of the second controller (19). A mobile device and/or a computation device can also send and/or receive wireless communication signals to and/or from both controllers to control the variable speed valve and/or monitor sensory data at a plurality of different local Variable Speed Valve locations. The mobile device is the central controller, in-which control's one or more Variable speed Valves connected to a plurality of main unit/second controllers (19). From this point, this patent will turn attention from the Variable speed Valve, and turn its attention towards a plurality of Controller and/or User Interfaces for one or more Variable Speed Valves. These controllers communicate with all Variable speed Valves in an online network and/or offline network. The following will discuss the Network Controllers different methods of construction and/or different functionalities for different system usages.

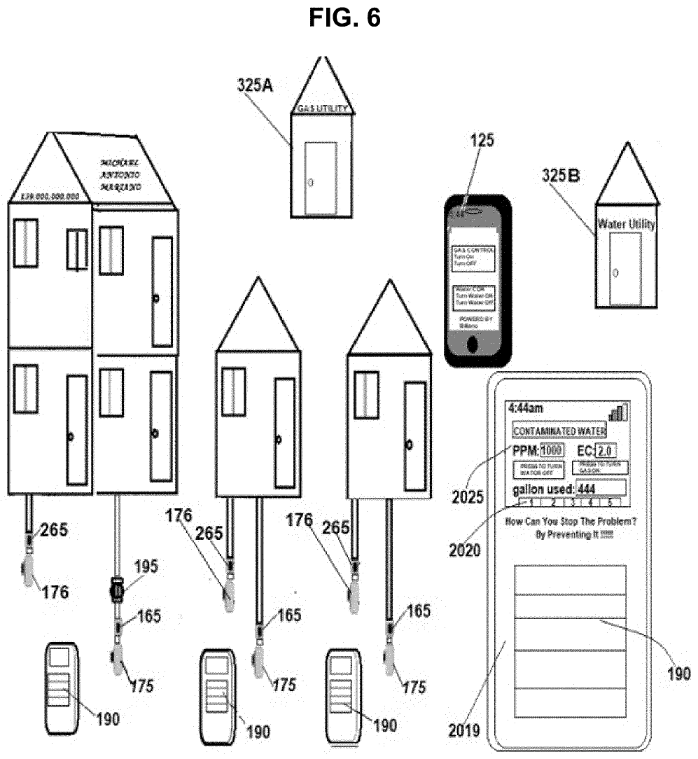

FIG. 6 Illustrates the “VSV with NCS” and its connectivity between a plurality of solar powered (190) and/or water turbine powered (195) local controllers (2019) and a plurality of central controllers ((125) and (325)). The illustration further depicts how the Variable speed Valves ((175) and (176)) is connected to the local controller (2019) at each water main line and/or Gas main-line connection of each user's home and/or business. Furthermore, depicts how the water company (325B), the Gas company (325A), the local controller (2019), and/or central controller (325)/mobile central controller (125) can control the actuating speed of the Variable speed valves ((175) and (176)), and moreover, control the pressure and/or flow of water and/or Gas entering each user's home. Moreover, depicts how the water company (325B), the Gas Company (325A), the local controller (2019), and/or a mobile device (125) can monitor and/or control the actuating speed of the Variable speed valve (175), and moreover, monitor and/or control the water pressure, water contaminants, temperature, water meter, and/or flow of the water entering each user's home by reading the sensory (165) data at the local controller. In addition, the central controller (325) and/or mobile central controller (125) can monitor and/or control the Gas pressure, gas flow-rate, gas meter, and/or the flow of the GAS entering each user's home by reading the sensory (265) data at the local controller. The local controller's (2019) solar panel (190), for example, is first embedded into the top of the water main enclosure, or concerning the Gas line, will be embedded in the gas main enclosure. The gas main and the water main can also be one local controller (2019), and both, the gas main and the water main, can be monitored and/or controlled from one or more central controllers. Next, the local controller unit and the battery is embedded in the bottom of the water main enclosure or the the local controller unit and the battery is embedded in the bottom of the gas-main enclosure. The user interface (2025), for example, is also embedded in the top of the water main enclosure and/or in the top of the Gas Main enclosure. In a whole, the water main enclosure, and/or the Gas main enclosure, are the local controller (2019). The local controller (2019) is constructed with a solar panel (190), user interface (2025), microcontroller s, radio controller device, sensors, drivers, battery(s), and/or battery charging circuitry. Now, concerning connecting the device for operation. First: connect the Variable speed Valves ((175) or (176)) and sensors (165) to the Water main line input or the gas main line input. If the Sensory inputs (165) are external devices, attach the Variable speed Valves ((175) and/or (176)) to the water main line or gas main line, and following the Variable Speed Valves ((175) and/or (176)) connection, connect the external sensory devices (165) to the output of the Variable Speed Valve ((175) and/or (176)). Moreover, connect the output of the Variable Speed Valves ((175) and/or (176)) or the output of the sensors to the input main pipeline in which is entering the home and/or facility. Now all physical connections are complete. To power-up and/or charge the device, a first charging system method was implemented in-which a user will connect a turbine generator (195) in-line with the Variable speed valves (175) and/or (176) and/or external sensors (165) and/or(265) output. This turbine (195) will Charge and power the device/batteries every time water is turned on in the user's home and/or will Charge and power the device/batteries every time gas flows into a users home. A second charging system method was implemented in-which a user will connect a Solar Panel (190) to the power input of the local controller (2019) to power up and/or charge the apparatus. These two Power methods were configured wherein a user can power the device without the need to plug the device in. After the Variable Speed Valve(s) ((175) and/or (176)), sensors (165) and/or (265) and/or a user power method is connected, the local controller (2019) is wired and/or send wireless control signals to communicate with the sensory inputs ((165) and/or (265)), the turbine generators (195), the Solar Panel(s) (190), and/or the Variable Speed Valves (175) and/or (176)). Each local “VSV with NCS devices, at each home and/or facility, can be controlled and/or monitored from its on local user interface (2019) and/or from either central controller's (125) and (325) users' interface. If the water utility company's and/or the Gas Utility Company's central controller (325) (computation device) turns off a user's facility Water and/or Gas because of unpaid bills and/or servicing purposes, a selected user cannot use any of their personal controllers (190) or (125) to open and/or close the Variable Speed Valves ((175) and/or (176)). The selected user can only regain access to the Variable Speed Valve s ((175) and/or (176)) if a user has paid their water and/or Gas bill and/or Utility servicing is complete, furthermore, the Water Utility company's and/or the Gas Utility Company's central controller (325) must output a communication signal to the individual local controller to unlock the device to allow a user to now use there on personal central controllers (125) and/or local controllers (190) to operate the apparatus. All controllers ((325) (190) (125)) user interfaces is constructed with one or more visual, auditory, motion sensors, and/or light sensors inputs to proportional actuate one or more Variable Speed Valve's open and/or closed, and furthermore, all controllers ((325) (190) (125)) also has visual outputs, auditory outputs, tactile outputs, and a microcontrollers which contain function's which can monitor, regulate, and/or control the pressure and/or flow of water and/or gas which is flowing into the user's home and/or business. In addition, the water main peripheral system has functions and settings to set the water main peripheral to output a predetermined volume of water (prepaid service), to output water on a predetermined time schedule, and/or to output a predetermined pressure of water. The Gas main peripheral system also has functions and settings to set the Gas main peripheral to output a predetermined volume of gas (prepaid service), to output gas on a predetermined time schedule, and/or to output a predetermined pressure and/or flow of Gas. The sensory inputs ((165) are used to monitor, sense, save, and/or determine water flow, water pressure, PH level, TDS, EC, water leaks,contaminants in water, and/or water temperatures in conjunction with the local water supply, moreover, the water sensors (165) send that saved recorded data to the local controllers (190) and/or central controllers ((325) (125)) microcontroller which will send signals to the user interface, to let the user know the Variable Speed Valves (175) position, to monitor sensory ((165) and/or (265)) inputs, and/or display sensory (165) data and/or valve (175) positioning data. The sensory inputs (265) are used to monitor, sense, save, and/or determine Gas flow, Gas pressure, Gas filtration, and/or Gas leaks in conjunction with the Gas supply, moreover, Gas sensors (265) send that recorded data to the local controllers (190) and/or central controllers ((325) (125)) microcontroller which will save and send signals to the user interface, to let the user know the Variable Speed Valves (176) position, to monitor sensory (265) inputs, and/or display sensory (265) data and/or valve (176) positioning data. The turbine generators (195) are an electric generator with its electricity and current generated by how fast the, water is flowing and/or the gas is flowing, through the generator device at the local water and/or gas supply. The turbine generators (195) is connected to the battery charging circuitry upon the local controller (2019) to charge the embedded battery upon the local controller (2019) every time a user runs the water or turn gas on in their home and/or business, while still also receiving a charge from the solar panel (190) upon the local controllers (2019). This charging circuitry allow the local controller's (2019) in the front of each user's home and/or business to self-charge. This specific device will operate in an online and/or offline network. The apparatus can operate on an online network via its Wi-Fi radio controller, but this specific route needs to be connected through a router at each home. The apparatus can operate on an off-line personal long-range network controlled via LoRa-Wan or any type of low power wide area network device. The LoRa-Wan device is very special when it comes to electronic water distribution in an offline network. Bluetooth will be utilized as well, but the communication range is very short. LoRa-Wan is special because it does not need any special towers to communicate in its wide area network. LoRa-Wan will allow each home and/or business to be its on router/tower, which means, the more devices that is connected to local water supplies in front of each user's home and/or business, the better the communication range for the water company to reach a device connected to any home and/or business. The LoRa-Wan device upon each local controller will allow signals to hop off of each local controllers LoRa-Wan device to reach the Variable Speed Valve that it supposes to operate upon. If a personal user wants to operate the LoRa-Wan device, they will need a Variable speed Valve Lora Network Controller. The Variable speed Valve Lora Network Controller directly communicate with the LoRa-Wan device. A user can also utilize a Lora-Wan gateway to hook up to their online network. This will also allow a user to communicate with the LoRa-Wan device at the local controller (2019). If a User has a LoRa gateway, the Variable Speed Valve Mobile APP will communicate with an API, furthermore, the API will transmit data from the world wide web to a user's LoRa-Wan gateway. Once data is reached at the users LoRa gateway, a user can reach any LoRa-Wan device on their private LoRa Wide Area Network from anywhere in the world.

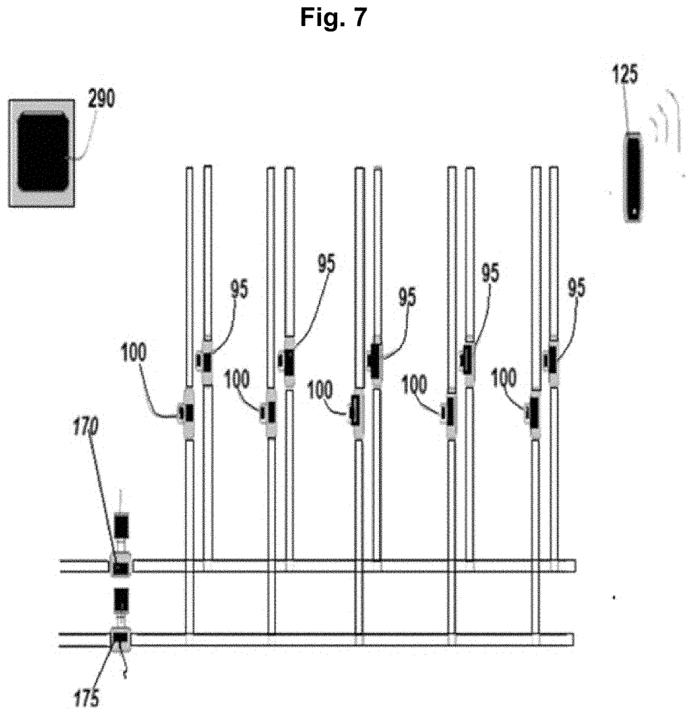

FIG. 7 Illustrates the “VSV with NCS” and its connectivity between a central network controller (125), one or more local controllers (290), and a pipeline system. Furthermore, the local controllers (290) are connected to a plurality of Variable Speed Valves upon a water, gas, oil, and/or air piping system. This Illustration depicts how the central network controller (125) and/or local controller (290) can monitor and/or control the flow and/or pressure at each Variable Speed Valve (95) and (100), in-which is connected at each branch of pipelines. This Illustration also depicts how the two main-line Variable speed valve's (170) and (175) flow and/or pressure's is controlled via the central network controller (125) and/or local controller (290). All controllers ((290) (125)) user interfaces are constructed with one or more inputs to proportional actuate one or more main line Variable Speed Valves (170) and (175), open and/or closed, to control the overall pressure for all pipeline branches, furthermore, all controllers ((290) (125)) also can proportionally actuate one or more individual branches Variable Speed Valves (95) and (100) to control the flow and/or pressure at each particular pipeline branch. The central network controller (125) and/or local controller (290) can also set, how fast, in-which a user wants each valve to actuate. A user can set one or more Variable Speed Valves to actuate fast and/or they can set a second/third/or fourth plurality of Variable Speed Valves to actuate slowly. A User can set one branch of pipelines to control gas (liquid or vapor) and set the other branch of pipelines to control oil/oil base products. The user can also set one branch of pipelines to control water and set the other branch of pipelines to control Air. The exceptional part of this apparatus is that it can control each individual pipeline from one single controller, and it doesn't matter if a plurality of different substances is flowing through each pipeline. Depending on the controller, each controller will have settings for Water, Gas, Oil, and/or Air. One specific controller (290) or (125) has settings for all the said utilities. This specific set up will be utilized, for example, in multi-zone sprinklers systems to electronically adjust the valve actuation speed, water pressure, and/or water flow to keep the sprinklers from wasting water by watering the city streets. This specific set up will be utilized in water distribution environments to electronically distribute water to city streets. This specific set up will be utilized in oil refineries to electronically distribute liquid and/or air to different parts of their specific environment. This specific set up will also be utilized in air pipelines, wherein a user utilizes compressed air in different zones of their work environment, in which the apparatus will control the flow and/or pressure at each valve at each zone and/or at each station. This set up can also be utilized in secure environments to electronically distribute liquid and/or air to different parts of their specific environment. The Variable Speed Valve pipeline system can also have sensors attached at each main branch and/or each local pipeline. Each Sensor will be controlled and/or monitored by the Central network controller (125) and/or one or more local controller's (290). This specific electronic water distribution setup, can and will, change in conjunction with this apparatus. What this mean is that this electronic distributed water pipeline setup, can and will be, constructed with any and/or all Variable Speed Valves ((170) (175) (95) (100)), with or without sensors. It will also be constructed with Solenoid Valves and/or Variable Speed Valves to control the actuation speed for each Valve, the pressure at each valve, and/or the flow at each Valve.

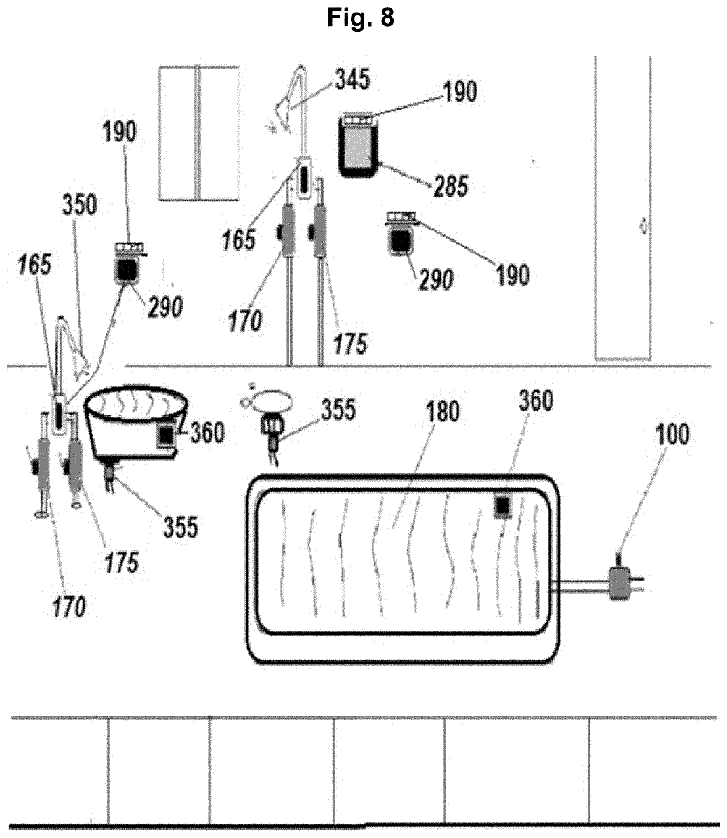

FIG. 8 Illustrates the “VSV with NCS” and its connectivity between the solar powered central controller (285) and a plurality of solar powered local controllers (290). Furthermore, the plurality of local controllers (290) is connected to sensory inputs(165), solenoid valves, and/or Variable Speed Valves outside a user's home. Moreover, the plurality of local controllers (290) is connected to a plurality of systems, at a plurality of local water supply connections, such as: showers (345), a tub (350), and/or a swimming pool (180). Solar power is the conversion of energy from sunlight into electricity, either directly using photovoltaics (PV), indirectly using concentrated solar power, or a combination. The solar power panel (190) is either embedded with the user's central controller (285) user interface and/or the solar panel (190) can be an external device. The central controllers (285) are either a self-contained wired and/or wireless controller with user interface inputs such as physical switches, motion sensors, voice command, touch screen, and/or any input type. The central controller (285) can also be a mobile device, and/or a computation Device. The central controller's (285) is utilized to send and/or receive control signals to and/or from a plurality of local controllers (290), in which are connected to the shower (345), the tub (350), and/or the swimming pool (180). The local controllers (290) also have there on user interface to control there on individual peripheral devices. This particular local controller (290) that's connected to the shower's (345) local water supply is constructed with Hot water (170) and/or cold water (175) Variable Speed Valves and water monitoring sensors (165). The central controller (285) and/or the local controller (290) can monitor and/or control the temperature, pressure, and/or flow of water which is outputting from the shower (345). The shower (345) system can, set and/or save, a plurality of functions in which allow the apparatus to output a predetermined temperature, on a predetermined time schedule, and/or the user can play a predetermined song utilizing the apparatus's wired/and or wireless audio system (505). The particular local controller (290) that's connected to the Tub (350) local water supply is constructed with Hot water (170) and/or cold water (175) Variable Speed Valves, water level sensors (360), and/or water monitoring sensors (165). The central controllers (285) and/or the local controllers (290) can monitor and/or control the temperature, pressure, and/or flow of water which is flowing into the tub (350), furthermore, the tub (350) system has water overflow protection sensors (360) that will never let a user's tub (350) over flow. The water overflow sensors also will be utilized as leak detection sensors in which they are exactly the same. Also, a user can set and/or save a plurality of settings to operate the Tub peripheral on a predetermined temperature, output a predetermined volume of water, a predetermined water pressure, predetermined time schedule, and/or the user can play a predetermined song utilizing the apparatus's wired/and or wireless audio system (505). The particular local controller (290) that's connected to the swimming pool (180) local water supply is constructed with Variable Speed Valves (100), water level sensors (360), and/or water monitoring sensors (165). The central controllers (285) and/or the local controllers (290) can monitor the temperature and/or control the flow of water which is flowing into the swimming pool (350). Furthermore, the swimming pool (350) peripheral has wired and/or wireless water overflow protection sensors (360). The water overflow protection sensors (360) are constructed to never let a user's swimming pool (350) water level get low and/or will never let the water over flow. These features allow full automation fill and/or re-fill the water in the pool. The swimming pool (350) peripheral can set and/or save a plurality of functions, in which allow the peripheral (350) to output a predetermined volume of water into the pool, output water on a predetermined time schedule to fill up the pool, and/or the user can play a predetermined song utilizing the apparatus's wired/and or wireless audio system (505) while in the pool. These Peripheral devices is also constructed to control the pressure and/or flow of water for a drip system, mist system, swamp cooler unit, and/or an air conditioner unit. The sensory inputs (360) will determine the water temperature, water pressure, water level, moisture level, PH, Chlorine, EC, TDS, PPM, for the drip system, mist system, agriculture system(watering Crop), swamp coolers, and/or air conditioner systems.

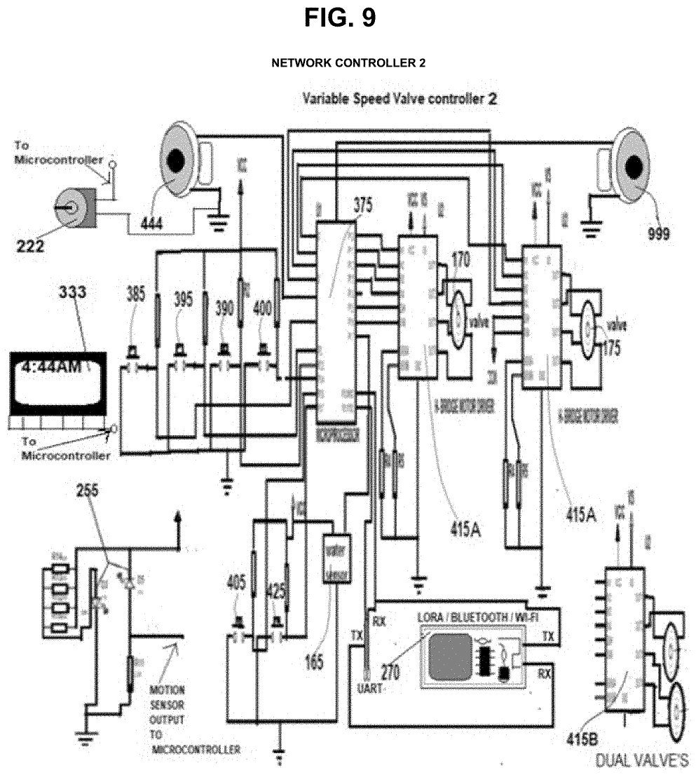

FIG. 9 Illustrates a second schematic of the “VSV with NCS” network controller's user interface and its connectivity to a plurality of inputs, such as, microphone (444), switches, motion sensor (255), sensory inputs (165), and/or Touch Screens (333). Moreover, the controller is constructed with outputs, such as, Speakers (999), Sensors (165), LED(s) (255), LCD(s) (333), vibration motors (222), and/or outputs in-which connects to one or more solenoid Valves ((415A (170) (175) or (415B)) and/or Variable Speed Valves ((415A (170) (175) and (415B)). The Plurality of LEDs, LCD screens, vibrator motors, touch screens, and/or speakers are utilized as outputs to output auditory, visual and/or tactile indications to a user. The system upon this schematic can operate any variable speed type motorized Valve and/or sensors, wherein the actuation device is a Solenoid, DC motor, AC motor, Servo motor, and/or Stepper motor. This electronic schematic also depicts, an example, of a plurality of different user interfaces upon the central controller (285) and/or the local controllers (290) (130), in which the controllers can be used in all figures. The user interfaces consist of a plurality of inputs, in-which the inputs are inputted into the microcontroller (375), to send a control signal to one or more drivers circuits (415), furthermore, the driver circuits then send an amplified signal to proportionally actuate the plurality of Variable Speed Valves. The plurality of inputs upon the user interface are hot+ (385) hot− (395) cold+ (390) cold− (400) warm+ (405) warm− (425), VSV select input (580), and a menu (365) input. The Speed settings can be adjusted in the menu settings and/or a user can set an input of their choice to set the speed of the Variable Speed Valves. The hot+ (385) input proportionally opens Variable Speed valves associated with the hot water. The hot− (395) input proportionally close Variable Speed valves associated with the hot water. The cold+ (390) input proportionally open Variable Speed valves associated with the cold water. The cold− (400) input proportionally close Variable Speed valves associated with the cold water. The warm+ (405) input proportionally open Variable Speed valves associated with the hot and cold water in unison. The warm− (425) input proportionally close Variable Speed valves associated with the hot and cold water in unison. The menu input (365) is used upon the central controller to select a different “VSV with NCS” peripheral system in-which will be fully controlled, but also is utilized to select, save, and/or change data in various functions in conjunction with the “VSV with NCS” plurality of peripheral systems. The menu input (365) is used upon the local controller (290) to select, save, and/or change data only in various functions in conjunction with the, locally connected, “VSV with NCS” peripheral system. The VSM select input (580) is used upon the central controllers (285) and/or the local controllers (290) for a user to select one or more Variable Speed Valves to actuate, open and/or closed, at a user's particular local piping supply. The VSV select input (580) can be used on all Figures to, start and/or stop, the flow of water at the local water supply connected to the “VSV with NCS” peripheral. The VSV select input (580) can be used on the shower and/or tub peripheral to, start and/or stop, the flow of water which flows through the shower local water supply and/or the flow of water which flows through the tub's local water supply. The VSV select input (580) can be used on a toilet peripheral to, start and/or stop, the flow of water which flows through the toilet's local water supply and/or if multiple toilets are present, the VSV select input (580) can select to enable or disable one or more toilets. If the toilet is disabled it cannot flush. The VSV select input (580) can be used on a kitchen peripheral to, start and/or stop, the flow of water, at each local water supply, which flows through one or more faucets at a local water supply, like an tap Water faucet/sink, osmosis system/faucet local water supply, and/or a pot-filler's faucet local water supply. The VSV select input (580) can be used on the pipelines peripheral to, start and/or stop, the flow of water in which flows through each individual branch of pipes, and furthermore, the pipeline peripheral can also control the pressure of each individual Pipe. If the pipeline peripheral was connected in a very large building/skyscraper building, the VSV select input (580) can, start and/or stop, the flow of water which flows to each floor of the building and/or is utilized to, start and/or stop, the flow of water which flows to each local water supply of the building, and moreover, the peripheral can also, control the water pressure and/or flow of water at each Variable Speed Valve connected in the building. The driver circuit (415) was constructed with a transistor(s), Mosfet(s), Darlington pair, and/or one or more H-bridge. The driver circuit (415) receives a signal pulses from the microcontroller to proportional actuate the motorized valves open and/or closed. This is a means to actuate a Variable Speed Valve at a plurality of speed settings and/or distribute exact flow and/or pressure control of a local Variable Speed Valve, due to the gearing system and pulsed signal operations. This particular setup can control 6 dc motor driven Variable Speed Valves, two dc motor and two stepper motor driven Variable Speed Valves, 10 or more servo driven Variable Speed valves, and/or can control three stepper motor driven Variable Speed valves. The apparatus can control, 10 or more servo driven Variable Speed valves, without a driver, due to the fact that a servo motor only needs a single signal from a microcontroller to be operated. The Vibrator circuit (222), is used as a physical/tactile indicator to the user. It can be set to vibrate the controller, before and/or after, a peripheral function starts and/or complete. A user can connect 100 or more Variables speed Valves to a plurality of local controllers, and furthermore control every single Variable Speed Valve from one or more central network controller. The sensory (165) inputs determine the Liquid, Air, and/or Gas temperature, Liquid, Air, and/or Gas presence, Liquid, Air, and/or Gas flow-rate, Liquid, Air, and/or Gas pressure, water oxygen level, water hardness, total chlorine in water, mercury in water, metals in water, fluoride in water, alkalinity, TDS (PPM), EC, and/or PH level in water. Photo/Light sensors will also be utilized to Power up and/or power down the device. Photo/Light sensors will also be used to automate a user's set night time functions and/or day time functions. For example, a photo sensor will be utilized instead of a timer to automatically actuate one or more Variable Speed valves, in-which will turn on a sprinkler system at night time. Another example, pertaining to the photo sensors, is wherein a user can set the photo sensor to power down the device at night time and set it to power-on at day time. A PIR Sensor will also be utilized for long distance human sensing, animal sensing, and/or object sensing. Sensors pertaining to a digital scale will be utilized in conjunction with the plurality of system controllers. For example, the top/face of a local and/or central controller has sensors to, if the controller is laid on a flat surface and laying down on that surface face up, a user can weigh food, substances, and/or liquids in measurement systems of the following units: lbs., ounces, liters, milliliters, grams, kilograms, and many more. All of the sensory inputs (165), utilized in conjunction with the apparatus, are commercially sold and communicate with the microcontroller(s) (75) through an input/output pin. The sensory inputs (165), that was stated above will, depending on the end user needs, all be utilized in conjunction with one or more “VSV with NCS” peripheral devices, Furthermore, the sensory (165) inputs send and/or receive data, to and/or from, the microcontroller (375) to monitor, determine, and/or to save sensory data that was recorded due to different types of activity at a local Variable Speed Valve. All said sensory inputs can automate the actuation of a Variable Speed Valves. The UART communication (270) is the communication method that was utilized, upon the microcontroller, to communicate with the wired and/or wireless Transceiver (270) communication devices. The “VSV with NCS” will use a plurality of wireless communication devices to communicate with each “VSV with NCS” peripheral device. Furthermore, the plurality of wireless communication devices that are used in conjunction with the “VSV with NCS” are LoRa-Wan, Zigbee, Bluetooth, WIFI, and/or any type of Radio Controller device. The Radio Controllers stated above are commercially sold modules that contains an on-board antenna, an on-board radio signal controller, and an on-board microcontroller. Using a radio-controlled type of communication system allows operation of the apparatus from anywhere around the user's home and/or business, hence the said radio controller devices also allow an internet connection to operate the “VSV with NCS” from anywhere in the world. The transceiver communication device in conjunction with all “VSV with NCS” peripheral devices will be able to operate in an online and/or offline network. The LoRa-Wan device have a Long range and can signal hop to get to the device it needs to control. If the user has the Lora-Wan device connected systems, the word LoRA-Wan is an acronym for Long Rage wide area network. On average, in an urban environment with an outdoor gateway, you can expect up to 2- to 3-km-wide coverage, while in the rural areas it can reach beyond 5 to 7 km. This aspect will allow a user to be able to operate a plurality of “VSV with NCS” in a long-range Network without the need for an internet connection. The peripheral systems that this schematic apply to are shown in all figures. This schematic also applies to other peripheral systems not yet foreseen, wherein, the system electronically controls the valve actuation speed, the flow of a pipeline, and/or the pressure of a local pipeline via a controller, sensors, and/or Variable Speed type Valves.

### Conclusion

In Conclusion, Various embodiments may include variations in the shape, material, construction method, size of various constructed machined parts, adjustable gearbox, motors, and/or valves used in conjunction with the “VSV with NCS”. Various embodiments may also allow for variations in the design of the electronic components used in conjunction with the “VSV with NCS” controllers.

The “VSV with NCS”, whether use is for water, Oil, Gas, and/or Air piping systems, indoor or outdoor, or whether using the “VSV with NCS” for preferred Pressure regulation, flow control, and/or temperature control, will move precisely and accurately to the position the user require. Furthermore, a user can control the actuation speed of the Variable Speed Valve Electronically and/or manually. Every time a user changes a setting upon the system, the apparatus will save data in its memory and will remember exactly how to reach any functions in which was previous set. Home and Business automation with the “VSV with NCS”, with or without, the Controller will substantially set a user at ease financially (water/gas bills) and keep the user stress free by accessing your Utilities more conveniently. In the Industry of Plumbing, Oil, Gas, and/or Air utilities today the need for easier application is essential. The “VSV with NCS” will allow all users to save preferred valve actuation speed, pressure, and/or temperature by one press of an input. The system can autonomously output a predetermined quantity of water, air, gas and/or oil by a single press of an input. Such said inputs include: voice command, motion sensors, touchscreen, Sensors, and/or any type of switch to control the said apparatus. Also, some sensory inputs are internal devices connected in conjunction with a local controller. These such sensory inputs monitor, control, and/or determines a substance weight, light sensing, tilt sensing, and/or fingerprint sensing. The “VSV with NCS” can and will be utilized for electronic distribution of water, oil, air, steam, gas, and any other distribution system that's controlled or can be controlled by a Valve. The Valve assembly can and will be any type of valve assembly. Depending upon which valve is utilized to create the electronic valve, the system will be titled as, for example, an Electronic Rationalizing Valve system, Electronic Rationalizing globe-valve system, and/or Electronic Rationalizing Ball-Valve system. Moreover, the acronym for the system's is ERB. Please take into consideration that this, electronically operated valve, will and/or can be controlled by any apparatus that can control sensors, motors, and/or solenoids. The “ VSV with NCS” actuating devices will be any type of motor, solenoid, sensory inputs, and/or valve assembly and moreover, will replace all valves in the near future.

I claim:

1. The motorized valve with an adjustable gearbox controlled in a network comprising:
An actuating devices, which received multiple signals from a controller to convert digital pulses into variable speed mechanical shaft rotation to proportionally and/or autonomously actuate a Valve, the actuating device connected to an adjustable gearbox to adjust actuating speed of the Valve; the adjustable gearbox being manually adjustable to a plurality of different gear pattern settings to vary the speed and/or torque of the valve; one or more driveshafts which links the adjustable gearbox to the valve; internal and/or external sensory devices in-which are utilized to monitor, determine, and/or control activity at one or more local pipelines, and/or sensory devices in-which are utilized to automate the actuation of one or more motorized valves; an emergency shut-off handle connected to the valve for shutting off the valve manually in case of emergency; wherein the motorized Valve system electronically and proportional output a precise fluid temperature, a precise predetermined quantity of air, a precise predetermined quantity of liquid, a precise predetermined quantity of gas, a precise predetermined quantity of oil, a specific valve position, a precise fluid pressure, and/or a precise air pressure.

2. The motorized valve of claim 1, wherein the actuating device(s) is a DC motor, stepper motor, servo motor, AC motor, and/or solenoid.

3. The motorized valve of claim 1, wherein the motorized valve is constructed with a ball valve, butterfly valve, diaphragm valve, globe Valve and/or any type of valve.

4. The motorized valve of claim 1, wherein the sensory inputs upon the valve are constructed as a removable device, interchangeable device, and/or stationary device, and/or moreover, utilized upon the apparatus to monitor, control, determine, and/or automate a precise liquid temperature, a precise quantity of liquid, air, and/or gas, liquid flow-rate, liquid pressure, liquid, air, and/or gas presence, air and/or gas pressure, substance detection, water oxygen level, fluoride in water, alkalinity, TDS (PPM), EC, PH level, and/or monitor, control, and/or automate one or more Motorized Valves.

5. The motorized valve of claim 1, wherein the motor and the adjustable gearbox is constructed as a removable device, wherein it can attach to and/or control any manual valve assembly and/or valve stem.

6. The motorized valve of claim 1, wherein the motorized valve has a position sensor and/or switch to monitor, calculate, automate, and/or determine one or more motorized valve position.

7. The motorized valve of claim 1, Wherein the motorized valve is a self-powered wireless controlled device and has batteries, a solar panel, and/or turbine generator to power the system and/or to recharge system batteries.

8. The system to control motorized valves with an adjustable gearbox in a network comprising:
An Network control system to monitor, automate, determine, and/or control the flow and/or pressure at one or more Motorized Valves in a online and/or offline network, and moreover, can variably control the speed in conjunction to how fast the valves actuate open and/or closed, the control system further includes;
a plurality of local controllers wherein each local controller includes: a transceiver, a first user interface for inputting control signals to control a flow and/or pressure of water, air, oil, and/or gas, and a first processor wherein the first processor receives user inputs from the first user interface and/or one or more sensor inputs and outputs first signals to control motorized valves connected to a local piping supply to control the pressure and/or flow of water, air, oil, and/or gas wherein the user inputs is a command to output a predetermined quantity of liquid, air, and/or gas, a predetermined liquid, air, and/or gas pressure, a predetermined liquid, air, and/or gas temperature, and/or output water, air, oil, and/or gas on a predetermined time schedule; and the sensory inputs causes the first processor to start or stop system power and/or causes the first processor to start or stop the flow of water, air, oil, and/or gas; and a central controller for communicating with each of the local controllers, wherein the central controller has a second user interface to send and/or receive control signals for monitoring and/or controlling the pressure and/or flow of water, air, oil, and/or gas at each of the local controllers, a second transceiver for communicating with each of the local controllers, a second processor for receiving the control signals from the second user interface wherein the second processor uses the second transceiver to send the control signals to one or more local controllers to control the pressure and/or flow of water, air, oil, and/or gas at the local controller and wherein the central controller receives input control signals from each of the local controllers.

9. The system to control motorized valves with an adjustable gearbox in a network in claim 8, further including visual, auditory, and/or tactile outputs at each of the central controllers and/or at each of the local controllers to indicate the status of one or more Valves at a central controller and/or local controller.

10. The system to control motorized valves with an adjustable gearbox in a network in claim 8, wherein the first and/or the second user interface is constructed with one or more motion sensors, LCD, touchscreen devices, microphones, and/or any type of switches.

11. The system to control motorized valves with an adjustable gearbox in a network in claim 8, wherein the first and/or the second transceivers communicates via a wire and/or wirelessly.

12. The system to control motorized valves with an adjustable gearbox in a network in claim 8, wherein the first and/or the second user interface is constructed with one or more motion sensors to recognize a human, animal, and/or object presence from long distances, short distances and/or for gesture control.

13. The system to control motorized valves with an adjustable gearbox in a network in claim 8, wherein the local controllers are connected to a piping installation in conjunction with a body of liquid and the sensory inputs determines the level of liquid in the body of liquid and if the body of liquid decrease under the sensory inputs, the body of liquid will automatically start to refill the liquid and stop refilling the liquid when the body of liquid reaches the sensory inputs.

14. The system to control motorized valves with an adjustable gearbox in a network in claim 8, wherein the local controllers are connected to monitor, automate, and/or control a piping installation and the sensory inputs in conjunction with the controller can detect liquid, air, and/or gas presence and in addition automate the positioning of a motorized valve.

15. The system to control motorized valves with an adjustable gearbox in a network in claim 8, wherein local controllers, valves, and/or sensory inputs monitor, determine, automate, and/or control the liquid temperature, liquid flow-rate, and/or liquid pressure outputting from one or more local motorized valve; and/or moreover, the controller can be set to, if the liquid is too hot for human use, automatically shut off the hot liquid supply until the liquid temperature is under the predetermined temperature.

16. The system to control motorized valves with an adjustable gearbox in a network in claim 8, wherein the local controllers and sensory inputs are connected to automate, monitor, and/or control one or more sinks, faucets, showers, toilets, and/or tubs.

17. The system to control motorized valves with an adjustable gearbox in a network in claim 8, wherein a toilet, a toilet's controller, and/or sensory inputs determine if a toilet was flushed; and/or if the toilet is determined to be flushed, the toilets local controller will send a control signal to the sinks, shower, and/or tub's local controller to turn on the water to a predetermined temperature, a predetermined pressure, a predetermined quantity, for a predetermine time period, and/or automatically turn the water off.

18. The system to control motorized valves with an adjustable gearbox in a network in claim 8, wherein the local controllers are connected to automate, monitor, and/or control one or more sprinkler systems, swimming pools, spas, swamp cooler's and/or air conditioner's, and the sensory inputs connected to the sprinkler systems, swimming pools, spas, swamp cooler and/or air conditioner's can monitor, control, and automate the position of one or more motorized valves.

19. The system to control motorized valves with an adjustable gearbox in a network in claim 8, wherein the controllers and/or the sensory inputs can monitor, control, determine, and/or automate the pressure and/or flow for an oil refinery/pipeline, air distribution system, and/or any type of utility local pipeline system, utilizing any type of motorized valves and/or sensory inputs.

20. The system to control motorized valves with an adjustable gearbox in a network in claim 8, wherein the sensory inputs are external devices in-which monitor, control, automate, and/or determines liquid contaminants, liquid purity, TDS, PPM, PH, EC, temperature, pressure, and/or flow-rate at a local controller, and/or the sensory inputs are internal devices connected to a local controller in-which monitor, control, and/or determines a substance weight, light sensing, tilt sensing, and/or fingerprint sensing at a local controller.

21. The system to control motorized valves with an adjustable gearbox in a network in claim 8, wherein the central controller, and/or the local controllers has batteries, a solar panel, and/or turbine generator to power the controllers and/or to recharge system batteries.

22. The system to control motorized valves with an adjustable gearbox in a network in claim 8, wherein a central controller is housed in a water utility facility and/or gas utility facility to send and/or receive control signals to and/or from a plurality of local controllers and/or sensors to determine, monitor, control, and/or automate the pressure and/or flow of water and/or gas at one or more local controllers connected to motorized Valves at one or more main pipelines.

23. The system to control motorized valves with an adjustable gearbox in a network in claim 8, wherein the central controller is implanted on a smart phone and/or the central controller is implanted on a computation device.

24. The system to control motorized valves with an adjustable gearbox in a network in claim 8, wherein one or more central controller can manually and/or autonomously control an entire city, state, province, and/or world's water and/or gas utility supply in-which is connected to a plurality of local controllers.

25. The system to control motorized valves with an adjustable gearbox in a network in claim 8, wherein the central controller and/or the local controller operates on a Long-range Wide area network and/or wireless mesh network(s).
